(19) United States
(12) Patent Application Publication
(10) Pub. No.: US 2026/0202182 A1
(43) Pub. Date: Jul. 16, 2026

(54) SYSTEMS AND METHODS FOR IDENTIFYING MARINE UNEXPLODED ORDINANCE (UXO)

(71) Applicant: FNV IP B.V., Leidschendam (NL)

(72) Inventors: Vsevolod KOVALENKO, Leidschendam (NL); Lotte VAN KERKHOVEN, Leidschendam (NL); Peter NIEUWVELD, Leidschendam (NL); Evert SLOB, Leidschendam (NL)

(73) Assignee: FNV IP B.V., Leidschendam (NL)

(21) Appl. No.: 19/134,659

(22) PCT Filed: Dec. 18, 2023
(86) PCT No.: PCT/EP2023/086439

§ 371 Date: May 30, 2025

(30) Foreign Application Priority Data
Dec. 22, 2022 (NL) 2033802

(51) Int. Cl. F42D 5/02; G01D 5/12

(52) U.S. Cl. CPC F42D 5/02; G01D 5/12

(57) ABSTRACT

Systems and methods for identifying marine unexploded ordinance (UXO) are provided. A magnetic moment of a candidate UXO is determined based on vector residual field magnetic data. Anomaly description data is determined using the magnetic moment including an estimate of at least two dimensions of the candidate UXO. A determination is made as to whether the anomaly description data fits with a reference description of a UXO to identify the candidate UXO as a probable UXO. An output device is controlled to provide an indication of the probable UXO. Unlocking insights from Geo-Data, the present invention further relates to improvements in sustainability and environmental developments: together we create a safe and liveable world.

### FIELD

The present disclosure generally relates to systems and methods for identifying marine unexploded ordinance (UXO). The present disclosure more particularly relates to systems and methods for processing magnetic field data to determine data describing characteristics of a candidate UXO. Unlocking insights from Geo-Data, the present invention further relates to improvements in sustainability and environmental developments: together we create a safe and liveable world.

### BACKGROUND

Magnetometry is a common survey technique for the detection of Unexploded Ordnances (UXOs) including marine (or offshore) UXOs. Detection of a UXO by a magnetometer survey is based on the fact that most UXO's are ferromagnetic as they are often made out of steel. They therefore have a magnetic susceptibility that is higher than its surrounding and create a detectable magnetic anomaly.

In the North Sea between Great Britain, Norway, Denmark, Germany, the Netherlands and Belgium, there is known to be a large quantity of unexploded munitions from World War (WW) II. In addition to dropped aerial bombs during World War II, sea mines from the First and Second World War and dumped ammunition after WW II still roam the North Sea. One estimate values the amount of dumped ammunition after WW II in the Baltic sea as 1.3 million tonnes, and in the North Sea as 300 thousand tonnes. Both are a mix of conventional and chemical munitions ranging in size from cases of rifle rounds to large aerial bombs. Detection of UXOs is exemplified here with respect to the North Sea and Baltic Sea but it remains a problem in different marine regions throughout the world.

Hazardous UXOs are not the only objects which generate a magnetic anomaly in and below the seafloor. Scrap metal and other types of waste have the potential to generate magnetic anomaly fields of a similar size as UXOs. From a practical and legal perspective, confirming whether an object is, or is not, a UXO is performed by visual inspection. A certified UXO expert must view the object and make a determination as to its classification. Most UXOs on the seabed are buried, and must be dug out before a visual classification can be made. Such visual classifications are expensive in terms of time and equipment use and also come with safety risks for the operating personnel. In one estimate, over 90% of potential (candidate) UXOs (pUXOs) turn out not to be UXOs but rather false alarms (false positives), leading to high operation costs to find and examine object that are likely not even hazardous. Of course, in particular when dealing with UXOs, false negatives by dismissing an anomaly which was in fact a real UXO, is highly undesirable.

An objective of the magnetic survey phase is to detect presence and location of candidate UXOs on or in the seabed and to determine something about the nature of the candidate UXO. A more precise detection of location of the candidate UXOs and reduction of erroneous UXO identifications would be beneficial to avoid uncovering material that is not a UXO.

Accordingly, it is desirable to provide systems and methods that more accurately detect, locate and classify marine UXOs, without leading to an increase in false negatives. It is further beneficial to exclude more magnetic field anomalies at the survey phase in a processing efficient and reliable manner. Furthermore, other desirable features and characteristics of the present invention will become apparent from the subsequent detailed description and the appended claims, taken in conjunction with the accompanying drawings and the foregoing technical field and background.

### OVERVIEW

In a first aspect, there is provided a method for identifying marine unexploded ordinance (UXO). The method includes: receiving, via at least one processor, vector residual field magnetic data including georeferenced magnetic field data in three directions, the vector residual magnetic data including an anomaly created by a candidate UXO; determining, via the at least one processor, a magnetic moment of the candidate UXO based on the vector residual field magnetic data; determining, via the at least one processor, anomaly description data using the magnetic moment including an estimate of at least two dimensions of the candidate UXO; determining, via the at least one processor, whether the anomaly description data fits with a reference description of a UXO to identify the candidate UXO as a probable UXO; and providing, via the at least one processor, an output to an output device, an indication of the probable UXO.

Existing techniques do not allow for ready distinguishing between a probable UXO and a non-UXO, which can lead to over 90% false positives and hence a costly inspection stage as all targets needs to be checked one by one. The subject matter disclosed herein makes it possible to distinguish within a target picking stage between probable UXOs (pUXO) and non-UXOs by leveraging vector magnetic field data to produce a greater description of candidate UXOs including an estimate of at least two (orthogonal) size dimensions of the UXO, thereby decreasing the chances of a false positive.

The ability to tell more than is currently possible about a buried object such as its size and shape can enable more objects to be excluded without having to uncover them. The subject matter described in this document provides, in embodiments, a new method to determine (from vector magnetometer survey data) first the location and orientation of an object, and then the likely shape of that object if it fits a magnetic model for a specified shape. There is a reasonable assumption made that an object which is not approximately the expected shape of a UXO would result in a poor or unresolved solution. Another assumption is that the better the shape of the detected object matches that of the model, the better the result of the algorithm will be.

In embodiments, the anomaly description data includes an orientation of the candidate UXO.

In embodiments, the anomaly description data includes a radius and a length of the candidate UXO as the at least two dimensions.

In embodiments, the anomaly description data includes a magnetic susceptibility of the candidate UXO.

In embodiments, determining the magnetic moment of the candidate UXO based on the vector residual field magnetic data includes performing a first inversion using a first model function representing a first model of the candidate UXO.

In embodiments, the first inversion estimates a location of the candidate UXO in three dimensions.

In embodiments, the first inversion includes a least squares inversion.

In embodiments, the first inversion assumes the candidate UXO is a dipole point source as the first model.

In embodiments, the first inversion is initialized with an initial estimate of a centre location of the candidate UXO and an initial estimate of a magnetic moment of the candidate UXO.

In embodiments, the initial estimate of the centre location is based on minimum and maximum values of the vector residual field magnetic data in at least two of three orthogonal directions.

In embodiments, the initial estimate of the magnetic moment is based on minimum and maximum values determined from reference UXO data.

In embodiments, the method comprises receiving, via at least one processor, orientation data describing an orientation of the candidate UXO and determining the anomaly description data uses the magnetic moment and the orientation data.

In embodiments, determining the anomaly description data using the magnetic moment comprises performing a second inversion using a second model function representing a second model of the candidate UXO.

In embodiments described herein, the method using an inversion algorithm (including the first and second inversions described above). Since a UXO can be modelled as a body of revolution whose asymmetry around its semi-major axis is minimal, it can be approached by a prolate spheroid as the second model. The prolate spheroid has a specific volume and orientation rather than just a dipole or monopole with a structural index. The subject matter described herein provides a vector data inversion method. The vector data inversion includes a two-step inversion algorithm in some embodiments. First, the magnetic dipole moment and the centre location are determined with a least-squares inversion, assuming the object is a point source. Second, the magnetic moment is fit into a prolate spheroid model (or another shaped model) to determine if the object creating the magnetic anomaly can be modelled as such and hence is a probable UXO.

In embodiments, the second inversion assumes the candidate UXO is a specified shape as the second model, optionally wherein the specified shape is a prolate spheroid.

In embodiments, the second inversion includes a first part that finds the estimate of at least two dimensions of the candidate UXO that best fits with reference UXO data.

In embodiments, the second inversion includes a second part that determines the magnetic susceptibility of the candidate UXO based on the estimate of at least two dimensions of the candidate UXO from the first part.

In embodiments, the second part is a basin hopping inversion.

In embodiments, the estimate of at least two dimensions includes a radius and/or a stretch factor of a prolate spheroid taken as the second model.

In embodiments, determining the anomaly description data using the magnetic moment comprises performing a second inversion using a second model function representing a second model of the candidate UXO, wherein the second inversion reduces an error between the magnetic moment provided by the first inversion and a calculated magnetic moment determined based on the second model function to provide an output of the second inversion, the output of the second inversion including values for parameters of the second model function, the values for parameters of the second model function included in the anomaly description data.

In embodiments, the error associated with the output of the second inversion is used to assess a quality of fit of the anomaly description data with the reference description of the UXO to determine whether the candidate UXO can be identified as a probable UXO.

In embodiments, the method further comprises using at least one vector magnetometer to provide the vector residual field magnetic data.

In embodiments, the at least one vector magnetometer is an optically pumped magnetometer.

In embodiments, a frame and a tow line support the at least one vector magnetometer to translate a towing force to the at least one vector magnetometer to move the at least one vector magnetometer through water.

In embodiments, the method further comprises using an acoustic detector to provide acoustic detection data including the orientation data of the candidate UXO.

In embodiments, the acoustic detector and/or the at least one vector magnetometer are supported by the frame.

In another aspect, a system is provided. The system comprises an output device; one or more processors in operable communication with the output device; and one or more memories having stored thereon computer readable instructions configured to cause the one or more processors to perform the methods as described above.

In embodiments, the system further comprises at least one vector magnetometer for providing the vector residual field magnetic data.

In embodiments, the at least one vector magnetometer is an optically pumped magnetometer.

In embodiments, the system further comprises a frame and a tow line, wherein the frame and the tow line are arranged to support the at least one vector magnetometer to translate a towing force to the at least one vector magnetometer such that the at least one vector magnetometer can be moved through water.

In embodiments, the system further comprises an acoustic detector providing acoustic detection data including orientation data of the candidate, wherein the orientation data describes an orientation of the candidate UXO and the anomaly description data is determined using the magnetic moment and the orientation data.

In embodiments, an acoustic detector and/or the at least one vector magnetometer are supported by the frame.

In another aspect, a computer readable medium comprises instructions, that, when executed by one or more data processing apparatus, cause the one or more data processing apparatus to perform operations according to the methods described above.

The systems and methods described herein go beyond use of only total field measurements or gradients of the measured total field. The subject matter described herein measure vector field components of the magnetic field. The present disclosure proposes a two-step inversion including a first inversion using a dipole point source model followed by a second inversion using a prolate spheroid (or other shaped) model. The dipole point source inversion for vector data uses a least-squares solver such as the Gauss-Newton method in some embodiments. The prolate spheroid inversion uses a Basin-hopping inversion. The second inversion estimates the orientation, shape, and magnetic susceptibility of the model. The magnetic susceptibility is found with the Basin-Hopping inversion in one embodiment with the other model parameters found using reference UXO data of expected UXOs in the region and finding a best fit of the model versus the magnetic moment from the first inversion. It has been found that vector data yields better results in terms of accuracy of location and magnetic moment and in terms of degree of description of a candidate UXO.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic view of a system for identifying UXOs including a magnetic detection device in a sensor housing and an associated processing system according to various embodiments;

FIG. 2 is a cross-sectional view of the magnetic detection device of claim 1 according to various embodiments;

FIG. 3 is a side-view of a system for identifying UXOs including another magnetic detection device showing two sensor housings positioned on a frame according to various embodiments;

FIG. 4 is a top view of a system for identifying UXOs including a yet further magnetic detection device showing a plurality of sensor housings positioned on a frame according to various embodiments;

FIG. 5 is a functional block diagram illustrating a processing system used in the systems and methods for identifying UXOs, in accordance with various embodiments;

FIG. 6 is a functional block diagram illustrating a modular system for identifying UXOs including data flows between modules, in accordance with various embodiments; and

FIG. 7 is a flowchart illustrating a method, in accordance with various embodiments.

### DETAILED DESCRIPTION OF THE DRAWINGS

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signalling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods described herein apply inversion processing techniques on vector magnetic field survey data, which allow more information to be derived concerning a candidate UXO and allow more accurate results to be generated in terms of localizing and classifying the candidate UXO. In embodiments described herein, a point source inversion is applied on vector field data to determine a magnetic moment and location of an anomaly in the vector field data, which is followed by an inversion assuming a model of a specified shape for the UXO such as a prolate spheroid model. The approach described herein aims to recover a variety of unknown parameters of the model having the specified shape including a description of at least two dimensions, the magnetic moment and magnetic susceptibility. In one embodiment, the model is a prolate spheroid model and the unknown parameters are radius, stretch factor, dip angle, azimuth, and magnetic susceptibility.

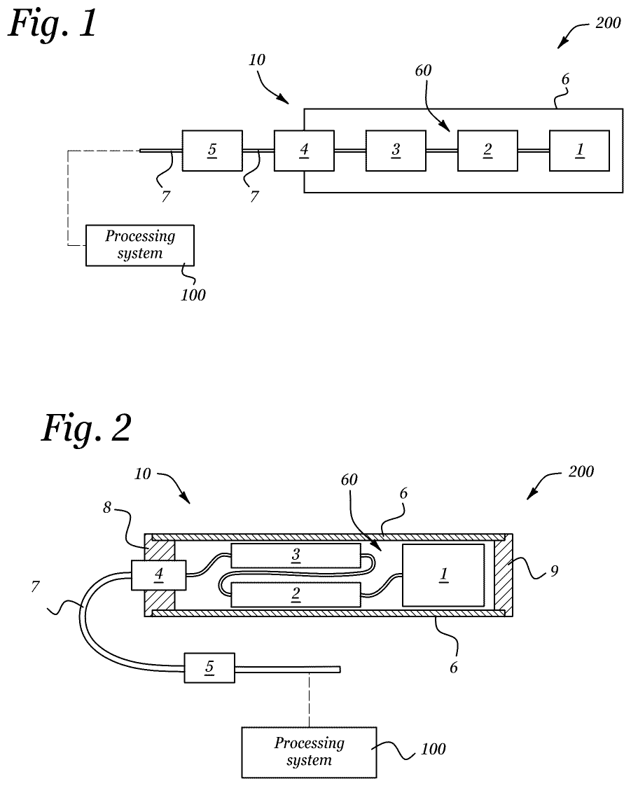

With reference to FIG. 1, a system 200 for identifying UXOs is illustrated in accordance with various embodiments. The system 200 includes a magnetic detection device 10 and a processing system 100. The magnetic detection device 10 is for measuring magnetic properties below the surface of the ground in marine environments (offshore). The processing system 100 receives the measured magnetic field data (which is in vector form) from the magnetic detection device 10 and performs various processing steps thereon in order to identify, classify and describe probable UXOs found in the vector magnetic field data. Referring also to FIG. 2, a cross-sectional view of the magnetic detection device 10 is shown. The shown embodiment of the magnetic detection device 10 comprises at least one sensor housing 6, the sensor housing 6 defining a housing space 60. The sensor housing 6 is arranged to prevent the ingress of water into the housing space 60 such that the magnetic detection device 10 can be towed behind a vessel without damaging the internal components in the sensor housing 6.

The shown embodiment of the magnetic detection device 10 comprises at least one optically pumped magnetometer 1 provided in the housing space 60 of the sensor housing 6. The optically pumped magnetometer 1 is an optically pumped vector magnetometer arranged to provide information on a magnetic field in three substantially orthogonal directions. The use of an optically pumped vector magnetometer 1 is advantageous as it is able to provide information on a magnetic field in three substantially orthogonal directions at a single point in time. That is, the optically pumped vector magnetometer 1 provides information about the total magnetic field and on the individual vector components in three orthogonal directions. The magnetometer 1 provides this information at a substantially single location and at a substantially single point in time, to provide an improved information quality and density.

The shown magnetic detection device 10 comprises an electronic control unit 2 and a communications board 3. These operate the magnetometer 1 and arrange the data transmission from the magnetometer 1 to e.g., a tow vessel. The electronic control unit 2 is arranged to instruct the optically pumped vector magnetometer 1 and to instruct when the magnetometer 1 takes the measurements.

The electronic control unit 2 is arranged to control the heating of a vapour cell of the optically pumped vector magnetometer 1 and is arranged to monitor characteristics of the optically pumped vector magnetometer 1 through one or more sensors provided therein. For example, the electronic control unit 2 may monitor the temperature of the vapour cell.

The electronic control unit 2 may further control a laser state and frequency of the laser in the optically pumped vector magnetometer 1, as well as detect and control the operational status of the one or more sensors in the optically pumped vector magnetometer 1. Furthermore, the electronic control unit 2 may sample the resulting data stream received from the optically pumped vector magnetometer 1 and may apply appropriate filtering to the incoming sensor data. A user may input the appropriate data filter. Alternatively, or additionally, the appropriate data filter may be determined by the system itself. For example, a noise filter may be applied to the data from the optically pumped vector magnetometer 1.

The communications board 3 then transmits the measurement results and/or measurement confirmation through to a tow vessel. The communications board 3 may also communicate information from a motion sensor to the tow vessel, so that measurement results from the magnetometer 1 can be correlated to positional data of the magnetic detection device 10.

The communications board 3 receives the output of the sensor from the electronic control unit 2 and is arranged to package the data for transmission in an appropriate format. Such format may e.g., be provided through the application of a USB protocol or RS232 protocol for use in a topside recording device such as a computer hard drive. The communications board 3 may also incorporate data from other sensors, such as e.g., the motion sensors, timing systems, altimeter, temperature sensors, or the like, in the data to be transmitted from the communications board 3.

The shown magnetic detection device 10 further comprises a bulkhead connector 4. The bulkhead connector 4 is arranged to provide a leak-proof transmission from the housing space 60 to the outside, allowing for data transmission between the magnetometer 1 and a tow line 7 arranged to transmit data from the magnetometer 1 to e.g., a tow vessel. The tow line 7 is arranged to transfer a towing force to the sensor housing 6. The tow line 7 may also be a data and/or power cable. If the tow line 7 is also a power cable, a power 30 converter 5 may be provided in the tow line 7. The power converter 5 may also contain a synchronisation pass-through function. The power converter 5 may be arranged to allow for conversion of transmitted power from e.g., a tow vessel to the sensor housing 6. The magnetic detection device shown in FIG. 2 also comprises a removable endcap 8 and a fixed endcap 9. These are arranged to keep the sensor housing 6 watertight to ensure no water leaks into the housing space 60. The removable endcap 8 and the fixed endcap 9 may be any suitable endcap and have any suitable geometry to attain the required depth rating of the sensor housing 6.

The vector magnetic field data provided by the magnetometer 1 and communicated through the communications board 3 is combined with global positioning data of a motion sensor (e.g. a Global Positioning System receiver). This results in georeferenced vector magnetic field data describing magnetic field measurements in three orthogonal directions for each of a population of sample locations. The sample locations may also be defined in three orthogonal dimensions—x, y and z coordinates. The vector magnetic field data is received by the processing system 100 for further processing to detect probable UXOs as described further herein.

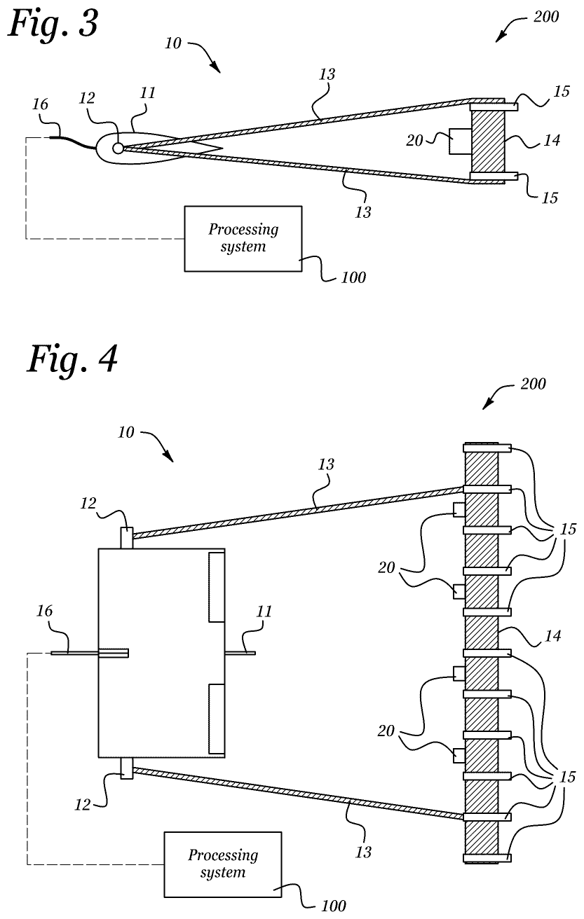

Now referring to FIG. 3, a side view of the magnetic detection device 10 according to another embodiment is shown. The magnetic detection device 1 of FIG. 3 comprises a frame 14 comprising two deployment frame arms 13. There may be more deployment frame arms 13 than those shown in the FIG. 3 embodiment. Two sensor housings 15 are positioned at a vertical distance from one another and are attached to the frame 14. There may be more sensor housings positioned behind the shown sensor housings. The magnetic detection device further comprises a subsea tow body 11, which is pivotably connected to the deployment frame arms 13 through axis 12. A tow line 16 is attached to the subsea tow body 11 to translate a towing force to the sensor housings 15 through the frame 14.

The subsea tow body 11 may be actively operated to adjust the depth of the magnetic detection device 1 and the magnetometers provided in the sensor housings 15. The subsea tow body 11 may be actuated around axis 12, to adjust the angle of the tow-body with respect to the vessel which tows the magnetic detection device 10 through tow line 16. The adjustment of the subsea tow body 11 alters the angle of attack in relation to the water through which the magnetic detection device is towed.

The tow body 11 comprises a hydrodynamic surface, which is arranged to provide lift to the magnetic detection device 10. With the actuation of the subsea tow body 11, the depth of the magnetic detection device 10 may thus be adjusted. Alternatively, the subsea tow body 11 is not actuated in an active manner but is passively towed behind the tow vessel through tow line 16. In such an embodiment, the subsea tow body 11 is arranged to stabilise the magnetic detection device within the water as it is towed behind the tow vessel.

The system 200 may further comprise one or more acoustic transducers 20. The acoustic transducer 20 may be positioned on the same frame 14 as the sensor housings 15, which may make geospatial matching of the magnetic field data and the acoustic data more accurate and processing efficient. The present disclosure is not limited with respect to the mounting location of the detection devices including the sensor housings 15 for the magnetic sensing and the acoustic transducers 20. For example, some or all of the detection devices can be mounted to frame 14, or to a second frame, if present, or to other portions of magnetic detection device. The acoustic transducers 20 may comprise an emitting acoustic transducer and plural receiving acoustic transducers that are spaced at regular intervals. In operation, the emitting acoustic transducer emits a high frequency acoustic signal, and reflections thereof are recorded by the receiving acoustic transducers. In other embodiments, the acoustic transducers are dual-mode acoustic transducers, which each have emitting and receiving capabilities. Each dual-mode transducer is capable of emitting a high-frequency acoustic signal, and is further capable of recording reflected signals that have either been emitted from other transducers or even from the present transducer at an earlier time. The high-frequency sound signal emitted by the acoustic transducer 20, and the reflections off any object under the seabed are recorded by acoustic transducer 20. The total traveling distance of the sound signal is then the sum of the hypotenuses of two right-angled triangles, the first triangle representing the traveling distance of the sound signal before reflection and the second triangle representing the traveling distance after reflection. A georeferenced acoustic map may thus be formed that will identify objects under the ground that strongly reflect the acoustic signal. This can provide depth and location of an object. The georeferenced acoustic map may be provided to the processing system 100 to support identification, classification and description of UXOs, as will be described further herein.

Now referring to FIG. 4, a top view of the magnetic detection device 1 according to an embodiment of the invention is shown. A plurality of sensor housings 15 are positioned on a frame 14, which comprises two (or more) deployment frame arms 13. A plurality of acoustic transducers 20 are also provided on the frame 14. The magnetic detection device further comprises a subsea tow body 11, which is pivotably connected to the deployment frame arms 13 through axis 12. A tow line 16 is attached to the subsea tow body 11 to translate a towing force to the sensor housings 15 through the frame 14.

FIGS. 1 to 4 provide one example of systems that are able to provide georeferenced vector magnetic field data to the processing system 100. However, other types of vector magnetic field detection device may be used. The processing system 100 may be provided with vector data from any other vector magnetometers usable in marine UXO survey applications.

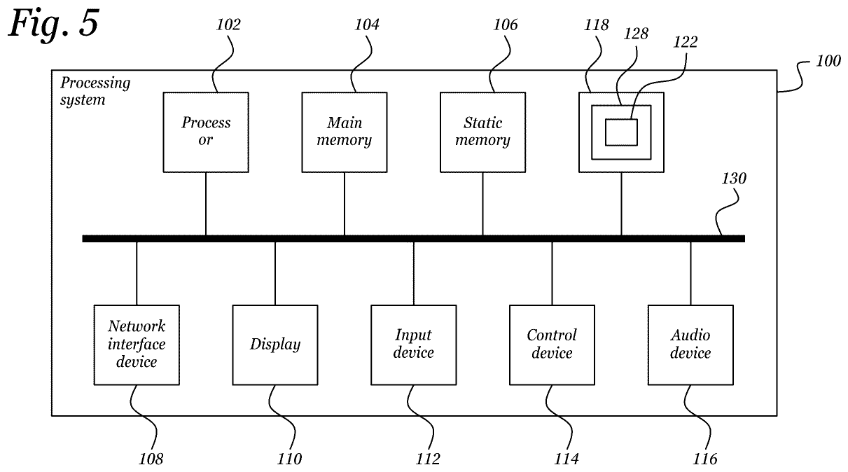

With reference to FIG. 5, the processing system 100 is further described according to exemplary embodiments. FIG. 5 shows a block diagram of one implementation of a processing system 100 in the form of a computing device within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example processing system 100 includes a processor 102, a main memory 104 (e.g., read-only memory (ROM), flash memory, dynamic random access memory (DRAM) such as synchronous DRAM (SDRAM) or Rambus DRAM (RDRAM), etc.), a static memory 106 (e.g., flash memory, static random access memory (SRAM), etc.), and a secondary memory (e.g., a data storage device 118), which communicate with each other via a bus 130.

Processor 102 represents one or more general-purpose processors such as a microprocessor, central processing unit, or the like. More particularly, the processor 102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 102 may also be one or more special-purpose processors such as an application specific integrated circuit (ASIC), a field programmable gate array (FPGA), a digital signal processor (DSP), network processor, or the like. Processor 102 is configured to execute the processing logic (instructions 122) for performing the operations and steps discussed herein.

The processing system 100 may further include a network interface device 108. The processing system 100 also may include a video display unit 110 (e.g., a liquid crystal display (LCD) or a cathode ray tube (CRT)), an alphanumeric input device 112 (e.g., a keyboard or touchscreen), a cursor control device 114 (e.g., a mouse or touchscreen), and an audio device 116 (e.g., a speaker).

It will be apparent that some features of the processing system 100 shown in FIG. 5 may be absent. For example, the processing system 100 may have no need for display device 110 (or any associated adapters). This may be the case, for example, for particular server-side computer apparatuses which are used only for their processing capabilities and do not need to display information to users. Similarly, user input device 112 may not be required. In its simplest form, processing system 100 comprises processor 102 and memory 104.

The data storage device 118 may include one or more machine-readable storage media (or more specifically one or more non-transitory computer-readable storage media) 128 on which is stored one or more sets of instructions 122 embodying any one or more of the methodologies or functions described herein. The instructions 122 may also reside, completely or at least partially, within the main memory 104 and/or within the processor 102 during execution thereof by the processing system 100, the main memory 104 and the processor 102 also constituting computer-readable storage media 128.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

The computer program is executable by the processor 102 to perform functions of the system 200 and methods described herein. In particular, the computer program is executable by the processor 102 to receive data collected during a magnetometer survey, to pre-process the data and then to further process the data through an inversion algorithm. The pre-processing may filter out noise such that an anomaly field is dealt with, i.e., a residual field. The residual field serves as the input data for the inversion algorithm. The inversion algorithm, in one embodiment, includes a point source inversion which results in a center location and a magnetic moment of a candidate UXO creating an anomaly. In this exemplary embodiment, a magnetic moment inversion using a model of a likely shape of the UXO is used to determine a radius, stretch factor, dip angle, azimuth, and magnetic susceptibility of the candidate UXO. Susceptibility is a dimensionless value which describes how strongly the object can bend the earth's magnetic field.

In an implementation, the modules, components, and other features described herein can be implemented as discrete components or integrated in the functionality of hardware components such as ASICS, FPGAs, DSPs, or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining,” “identifying,”, “receiving,”, “providing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

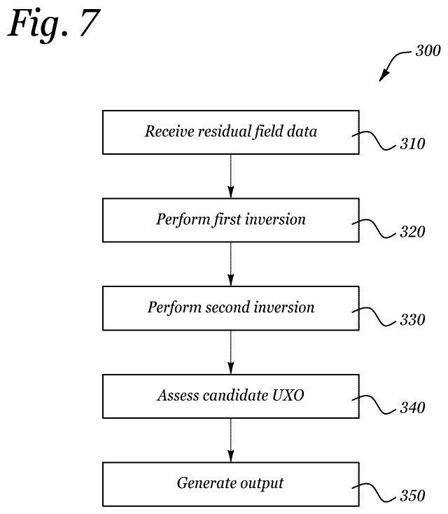

Referring to FIG. 7, the system 200 for identifying UXOs is described in further detail with respect to processing steps performed by various modules. The different modules are presented by way of example and further or less modules may be included according to any specific implementation. As has previously been described, vector magnetometers 204 serve as a source of vector magnetic field data 202. The vector magnetometers 204 may be according to that described above with reference to FIGS. 1 to 4 or otherwise arranged to conduct magnetic surveys and provide georeferenced magnetic field data in vector form with three orthogonal measurements of the magnetic field. The vector magnetic field data 202 thus provides an array of magnetic field strength measurements (intensity values) in orthogonal x, y and z directions for each of a population of x, y and z sample locations that are regularly distributed throughout a survey area. The x, y and z locations may be provided by GPS measurements as has been described heretofore. The z dimension may be constant where the survey is done by a boat moving along the surface of the sea with a constant depth measurement apparatus (e.g. as shown in FIGS. 1 to 4) towed behind. The vector magnetic field data 202 is provided to the processing system 100 through wired or wireless connections over a network or by transporting digital recording media including results of a magnetic survey or in any other way.

The vector magnetic field data 202 includes both the Earth's magnetic field B₀ (the inducing field) and an anomalous magnetic field (Ba) contribution by any ferromagnetic objects in the survey area. The Earth's magnetic field is eliminated, using the pre-processing module 206, by subtracting this known quantity at each sample location with an assumption of a constant Earth's inducing field over the extent of the survey area. The pre-processing module 206 thus provides residual field data 208 based on the vector magnetic field data 202 with the Earth's inducing field filtered out. The pre-processing module 206 may also take care of other noise sources. The residual field data 208 includes anomalous magnetic field measurements that are clustered in blobs and which are each georeferenced. This provides a plurality of candidate UXOs at different survey locations that are further processed by the processing system 100 to describe each candidate UXO in greater detail and also to determine whether such a candidate UXO is or is not a probable UXO.

The processing system 100 includes a model location initialization module 214 and a first inversion module 218 that are configured to determine estimated location and magnetic moment of each anomaly included in the residual field data 208. The localized regions of the residual field data 208 corresponding to an anomaly constituting a candidate UXO may be identified automatically or manually. A user may highlight a part of the residual field data 208 by outlining each anomalous region in a presented of residual field data 208 on the display 110 (FIG. 5). The outlining may be performed with the user input device 112 (FIG. 5). Alternatively, an automatic segmentation algorithm may be implemented such as by thresholding to remove small perturbations and background noise and threshold boundary determination to determine an outline for local regions or blobs that represent a candidate UXO. These regions of interest are then further processed to determine various properties of the candidate UXOs as described further herein.

The model location initialization module 214, the magnetic moment initialization module 262 and the first inversion module 218 represent a first step in an overall inversion performed by the processing system 100 where the goal is to obtain a centre location and magnetic moment of the candidate UXO by modelling the magnetic field as if it were created by a magnetic dipole. This first step in the inversion may be described as a point source inversion. The processing system 100 further includes a rotation inversion module 224 and a second inversion module 236. The rotation inversion module 224 and the second inversion module 236 use the retrieved magnetic moment from the first inversion module 218 as if were a prolate spheroid or some other three-dimensional shape of expected UXOs in the survey area (e.g. spherical, disc, cylindrical, etc.). The prolate spheroid or other three-dimensional shape is used as a simplified representation of a UXO-shape. The second inversion of the second inversion module 236 aims to find a best fitting radius, stretch factor, magnetic susceptibility, azimuth and dip angle according to an error between a calculated magnetic moment using these parameters and the prolate spheroid model (for example) and the magnetic moment found by the point source inversion of the first inversion module. This error shows how probable it is that the candidate UXO corresponds to the expected UXO shape of the model and thus whether or not it is a probable UXO. The second inversion of the second inversion module 236 may be described as a prolate spheroid inversion (or other model of an expected UXO shape).

The first inversion module 218 finds point dipole model parameters, i.e. the centre location of the object at (x₀, y₀, z₀) and its magnetic moment (m₁, m₂, m₃), from the observed signal, e.g. Bₓ, B_{y}, B_{z}. The observed signal corresponds to an anomaly region in the residual field data 208. The first inversion module 218 thus outputs estimated magnetic moment data 222 (m₁, m₂, m₃) and estimated location data 254 (x₀, y₀, z₀) for a candidate UXO. The first inversion module 218 make use of a first model function 220, which models the candidate UXO as a Magnetic field anomaly of a dipole point source according to the following equation:

$$B = \frac{1}{4 π R} [ 3 ( m \cdot \hat{r} ) \hat{r} - m ] \qquad ( equation 1 )$$

In equation 1, B is the magnetic field anomaly in nT according to the residual field data 208. R is the norm of the distance vector:

$$\sqrt{{( x - {x}_{0} )}^{2} + {( y - {y}_{0} )}^{2} + {( z - {z}_{0} )}^{2}} \qquad ( equation 2 )$$

\hat{r} is the unit distance vector r/R. m is the magnetic dipole moment.

The first inversion module 218 employs a solver algorithm to minimize (or reduce to an acceptable threshold) an error between calculated values for the magnetic field anomaly vector according to the first model function 220 (equation 1) and observed values according to the residual field data 208 by adjusting the model parameters (namely the magnetic moment (m₁, m₂, m₃) and the anomaly centre location (x₀, y₀, z₀). The residual (error) is calculated and accumulated over each datapoint for the candidate UXO. In some embodiments, the solver used by first inversion module 218 is a non-linear least square solver, which may, in some embodiments, employ a Gauss-Newton method. The Gauss-Newton method is well-suited for low-level non-linear functions such as the three component Bₓ, B_{y} and B_{z} data of the residual field data 208.)

The magnetic moment is a magnetic dipole moment in the present, i.e. the second of theoretically non-ending succession of magnetic moments which entirety describes/explains the observed magnetic anomaly fully. It has been found that the zeroth, first and fourth moments are zero by math and the fourth and fifth are relatively small effects that are difficult to measurable with current sensing technology but this may be possible in the future.

In an embodiment, the first inversion module 218 applies a linearization on the first model function with a preliminary estimate of the unknowns with the aid of a first-order Taylor series expansion. The preliminary estimate of the unknowns is provided by the model location initialization module 214 and the magnetic moment initialization module 262 as described in the following. The objective function represents the residual vector (or error as described above), which calculates the difference between the observed data according to the residual field data 208 and reconstructed data according to the first model function 220. The model parameters are iteratively updated until theoretically an objective function converges to its minimum. In practice, however, reaching the minimum may be too processing or time costly such that one or more thresholds will be set to define a stopping criterion; when the objective function drops below a certain value or if it does not change for a set of consecutive iterations.

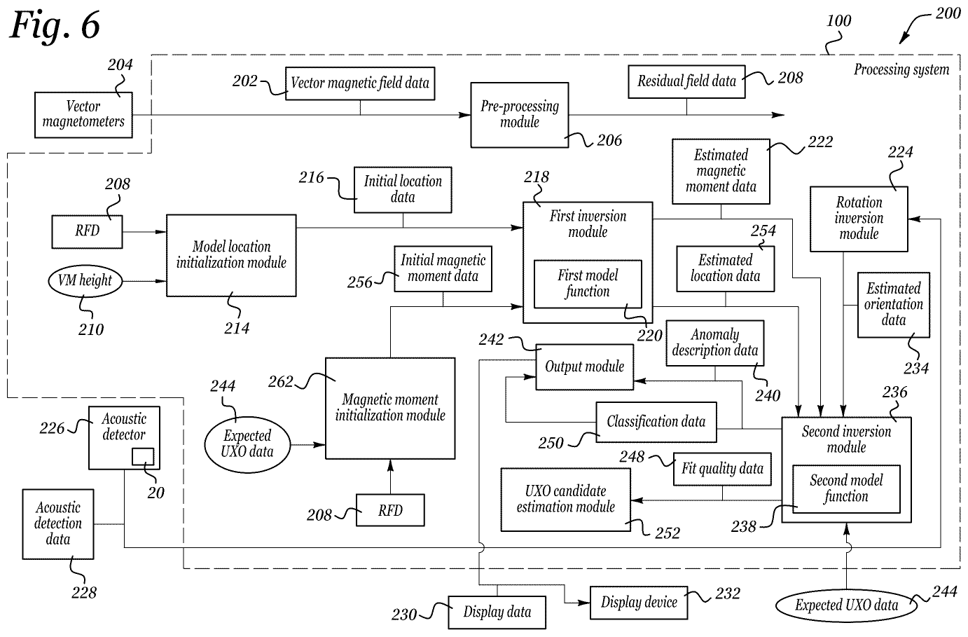

The first inversion module 218 determines the residual vector based on a difference or error between observed data provided by the residual field data 208 and reconstructed data calculated by the first model function 220 (including equation 1 above). The first model function 220 calculates the reconstructed data according to the dipole point source assumption described previously. Further, the first inversion module 218 determines the residual vector using an initial estimation of the centre location (x₀, y₀, z₀), which is shown in FIG. 6 as initial location data 216, and an initial estimate of the magnetic moment (m₁, m₂, m₃), which is shown as initial magnetic moment data 256 in FIG. 6.

The model location initialization module 214 provides the initial location data 216 including a centre location of the candidate UXO. A 2D centre location on a northing and easting plane (x₀, y₀) is taken at a location where B_{z} according to the residual field data 208 is at a maximum. An averaging filter may be applied to find the centre location, or the absolute values may be used. An interpolation may also be performed to find a more precise value, but this level of accuracy may not be needed for obtaining initial estimates. In another example, a middle point of a line connecting the maximum and minimum of B_{z} may be taken for x₀ and y₀. An underground depth of the candidate UXO z₀ may be found from a length of a line connecting minimum and maximum values of the anomaly of either Bₓ or B_{y}. This length shows a distance between the vector magnetometers 204 and the candidate UXO. Generally, the distance between the two extrema in Bₓ or B_{y} are similar. However, both lengths are determined (i.e., the length between minimum and maximum in Bₓ and minimum and maximum in B_{y}) and the smallest out of the two is taken as an estimation of the sensor-object distance. The model location initialization module 214 receives vector magnetometer height 210, which is a height above the ground (e.g., the seafloor) at which the residual field data 208 for the anomaly has been measured. This is data that is known and is included as metadata with the vector magnetic field data 202. The VM height 210 (or flight height) is subtracted from the estimation of the sensor-object distance to provide a burial depth of the candidate UXO. The model location initialization module 214 thus outputs x₀, y₀ and z₀ as the initial location data 216 to be refined by the first inversion module 218.

The magnetic moment initialization module 262 finds an initial estimate for the magnetic dipole moment (m₁, m₂, m₃), which is provided to the first inversion module 218 as initial magnetic moment data 256. Based on a desk-study of the area that has been surveyed, an estimate of which UXOs are expected to be found in a survey-area is made. The desktop study may include a historical study to determine whether any known conflict took place at the site in question, or if there is any documented evidence of mine-laying, practice firing, munitions dumping, etc. An outcome of this process is a list of potential munitions that could be expected to be found on the site along with a UXO risk assessment. This gives an expectation of what UXO's are the most likely to be found on the site. This information can be digitally stored as expected UXO data 244 (e.g., on storage media 128 in FIG. 5) for retrieval by the magnetic moment initialization module 262. The expected UXO data 244 can include a list of UXO identifiers and characteristics of such UXOs including radius, stretch factor and magnetic susceptibility where a prolate spheroid model is being used and other dimensional characteristics needed where other models are being used.

The magnetic moment vector m of a prolate spheroid can be modelled using the following equation:

$$m = \frac{{a}^{3}}{3} {A}^{T} {FAB}_{0} \qquad ( equation 3 )$$

In equation 3, a is a radius of semi-minor axes of the prolate spheroid, A is a Euler rotation matrix which rotates based on dip angle θ (with respect to the horizontal) and the azimuth φ (with respect to north) and F is a Form matrix containing information on the stretch factor e and the magnetic susceptibility χ of the candidate UXO.

With the aid of equation 3, the known radius and stretch factor matching with each expected UXO according to the expected UXO data 244, the maximum and minimum values of m₁, m₂, m₃ are calculated individually by the magnetic moment initialization module 262. These minima and maxima are found by rotating the UXO type to a specific dip angle and azimuth which maximizes or minimizes the magnetic moment in a model. From these minimum and maximum values, the average is taken and used as the initial magnetic moment data 256. Accordingly, a brute search can be used to determine the minimum and maximum values of the magnetic moment vector m by rotating each UXO and calculating the magnetic moment using the model of equation 3 and the value for radius and stretch factor (and optionally also magnetic susceptibility) according to the expected UXO data 244. The mean value for each component m₁, m₂ and m₃ across all types of UXOs included in the expected UXO data 244 according to the desktop study is taken as the initial magnetic moment data 256. In other embodiments, a weighted average may be taken based on an expected frequency of each type of UXO.

The first inversion module 218 takes the initial location data 216 and the initial magnetic moment data 256 and iteratively modifies the initial estimate until a local minimum of the first model function 220 (the dipole model) is found. The modification of the first guess may be through information in a Jacobian matrix when a Gauss Newton method is used but other non-linear iterative optimization algorithms can be used. The first inversion module 218 outputs the estimated magnetic moment data 222 and the estimated location data 254, which is used in a second inversion performed by the combination of the rotation inversion module 224 and the second inversion module 236.

The rotation inversion module 224 estimates azimuth and dip angles for the candidate UXO using initial estimates for one or both of these angles from the acoustic detector 226. The acoustic detector 226 includes the acoustic transducer 20 (or transducers). The acoustic detector 226 provides a georeferenced acoustic map that can be spatially matched with residual field data 208 so that a candidate UXO identified in the residual field data 208 can be matched with a candidate UXO in the acoustic map. The georeferenced acoustic map provides a three-dimensional representation of the candidate UXO. A user can draw a line, using the user input device 112 (FIG. 5) connecting elongate ends of the candidate UXO. Alternatively, an automatic algorithm can perform boundary detection on the candidate UXO and through shape matching or other automated methods, longitudinal ends of the candidate UXO can be found and a line connecting these ends can be automatically established. In this way, a direction of the line in three-dimensional space can be found and from that the azimuth and dip angles can be derived, which are incorporated in acoustic detection data 228 provided by the acoustic detector 226.

The orientation of the candidate UXO is determined by the rotation inversion module 224. Referring to equation 3 above, it has been found that the parameters within the Euler rotation matrix (azimuth φ and dip angle θ) can be found according by minimizing the objective function:

$$ψ ( ϕ , θ ) = min ( \vert {c}_{2} ( ϕ , θ ) - {c}_{3} ( ϕ , θ ) \vert ) \to 0 \qquad ( equation 4 )$$

where c₂ and c₃ are obtained from a diagonal matrix related to the form matrix F (equation 3). The orientation of the prolate spheroid that minimizes this objective function of equation 4 can be found by searching φ−θ space to find one of the two angles that matches the minimum using the known one of the angles. In some embodiments, the rotation inversion module 224 is not required where the acoustic detection data 228 already identifies the dip and azimuth angles with sufficient accuracy.

The second inversion module 236 receives the estimated orientation data 234 from the rotation inversion module 224 or directly from acoustic detection data 228. The second inversion module 236 further receives the expected UXO data 244 that has been retrieved from digital storage and is based on the desktop study described above. The second inversion module 236 aims to find the stretch factor, radius (of the semi-minor axis of the prolate spheroid and magnetic susceptibility of the second model function 238 that produces a calculated magnetic moment vector that best matches the estimated magnetic moment data 222 produced by the first inversion module 218. The second model function 238 is a prolate spheroid model having stretch factor, radius, magnetic susceptibility and orientation (azimuth and dip angles) in one embodiment, which can be according to equation 3 above. In other embodiments, different shaped models may be used as the second model function 238 such as a sphere (in which case the prolate spheroid model described herein has a stretch factor of 1), a cylinder, a disc, etc. and corresponding functions/equations can be derived for such models. The second inversion module 236 determines an error between an observed magnetic moment according to the estimated magnetic moment data 222 and an estimated magnetic moment according to the second model function 238. The second inversion module 236 iteratively adjusts values for the model parameters until a minimum is found or some other stopping criterion is reached (e.g. an error value is reached that is below a certain threshold or a threshold number of iterations has been reached). The second inversion module 236 outputs these values as anomaly description data 240, which also includes the estimated location data 254 from the first inversion module 218. As such, the second inversion module 236 is able to provide a full description of each candidate UXO, which can support in determining whether the candidate UXOs are probable UXOs. The second inversion module 236 may also output the error as fit quality data 248 for supporting assessment of the candidate UXO as a probable UXO.

In some embodiments, the second inversion module 236 takes a two-step approach to estimating the radius, stretch factor and magnetic susceptibility of the candidate UXO so that the radius and stretch factor are first determined (in the case of a prolate spheroid model) and second the magnetic susceptibility is determined. The expected UXO data 244 contains information on which types of UXO are expected to be found in the survey area and hence what kind of shape these UXOs have including their length (which corresponds to a stretch factor) and radius. The second inversion module 236 finding the best fitting UXO performs trial and error on each type of UXO in the expected UXO data 244 and takes an arbitrary but constant susceptibility value (e.g. 30). Given the orientation provided by the estimated orientation data 234, the arbitrary magnetic susceptibility, the expected radii and stretch factors from the expected UXO data 244, a brute force inversion is run to determine the UXO type of the expected UXO data 244 that has the minimum error between the observed magnetic moment of the estimated magnetic moment data 222 and the calculated magnetic moment determined by the second model function. With the radius and stretch factor of the UXO type that best fits the model, a further inversion is used to find the magnetic susceptibility that minimizes the error between the magnetic moment of the estimated magnetic moment data 222 and the calculated magnetic moment of the second model function 238. In this way, all of the parameters within the magnetic moment of a prolate spheroid (or other model of the second model function 238) are estimated and included in the anomaly description data 240. With this information, it is possible to determine whether the prolate spheroid model (or other model) fits well and hence whether a probable UXO is identified. In one embodiment, the second inversion module 236 uses a Basin-Hopping inversion to find the magnetic susceptibility but other error minimization/reduction algorithms are possible. In one embodiment, the error is a root mean square error such as a global normalized root mean square between the retrieved magnetic moment (estimated magnetic moment data 222) from the point source inversion of the first inversion module 218 and the reconstructed magnetic moment of a prolate spheroid (or other shaped model) with the aid of the second model function 238. The error may be output as fit quality data 248.

The processing system 100 may include a UXO candidate estimation module 252 that receives the fit quality data 248 and makes an assessment on whether the candidate UXO can be considered as a probable UXO. The fit quality data 248 is some representation of the error found by the second inversion module 236, which may be some kind of root mean square error value. The UXO candidate estimate module 252 may compare the error to a calibratable threshold that may depend on the noise level of the fit quality data 248. The second inversion quality of fit depends on a quality of the first inversion. That is, if the point source inversion is not performing well (has a high Root Mean Square error), the prolate spheroid model will start off with a less accurate magnetic moment and also return a higher RMS. Hence the calibratable threshold or other criteria for assessing a quality of fit of the model is adaptable to accommodate a less accurate case based on the performance of the point source inversion. Accordingly, the calibratable threshold may be adapted based on the noise level of the fit quality data 248 of the second inversion and/or corresponding fit quality data from the first inversion.

In this way, each candidate UXO in the residual field data 208 can be classified as either a probable UXO or not, which is output as classification data 250. In some embodiments, a third classification can be estimated based on the fit quality data 248 of possible UXO, which would be an intermediate classification between a classification of not a UXO and a probable UXO. The classification data 250 may be provided to an output module 242.

The output module 242 generates display data 230 for a display device 232 (corresponding to the display 110 of FIG. 5) to depict a result of the processing system 100. The depiction can include a classification of each candidate UXO according to the classification data 250 to indicate whether the candidate UXO is a probable UXO or not. The depiction can include a description of each candidate UXO that has been determined as a probable UXO according to the anomaly description data 240 including the dimensions (radius and length/elongation in a prolate spheroid model) of the probable UXO and optionally the further parameters including the magnetic susceptibility and the orientation. The display data 230 may represent a depiction of a map of the survey area with each probable UXO synthetically augmented according to the dimensions of the candidate UXO and with accompanying labels (e.g. pop-up labels) describing the further information found for the probable UXO according to the anomaly description data 240. The display data 230 may additionally depict (possibly as part of the synthetically augmented map) those candidate UXOs that have not been found to be probable UXOs possibly with colour coding to differentiate the UXO classifications. The display data 230 in map form may show each candidate UXO at a location set according to the estimated location data 254.

The display data 230 in other embodiments may be a list of all magnetic detections (candidate UXOs) along with their position and estimated depth of burial according to the estimated location data 254, as well as maximum peak-to-peak amplitude of the anomaly according to the residual field data 208. In some embodiments, the display data 230 may depict candidate UXOs that have been classified as probable UXOs for further investigation and is supported by charts produced during processing. In one embodiment, each probable UXO is displayed with a corresponding magnetic chart image produced based on the residual field data 208. Further, a multibeam image, sidescan sonar image and, if conducted, a sub-bottom image can be included in the display data 230 based on information from the acoustic detector 226.

In various embodiments, the display data 230 includes a list of probable UXOs with supporting metadata including the found orientation, magnetic susceptibility, length and radius. As described, such information can be included as to scale and localized synthetic objects added to magnetic charts that image the residual field data 208. The magnetic charts may be augmented with an acoustic image from acoustic data from the acoustic detector 226.

Referring now to FIG. 7, and with continued reference to FIGS. 1-6, a flowchart illustrates a method 300 of identifying a marine UXO that can be performed by the system 200 of FIGS. 1 to 6 in accordance with the present disclosure. As can be appreciated in light of the disclosure, the order of operation within the method is not limited to the sequential execution as illustrated in FIG. 7, but may be performed in one or more varying orders as applicable and in accordance with the present disclosure. The steps of the method 300 are performed by the processing system 100 described hereinabove.

Method 300 includes step 310 of receiving residual field data 208, which includes a measure of magnetic field in three orthogonal directions based on vector magnetic field data 202 provided by the vector magnetometers 204. Such vector magnetic field data 202 allows additional descriptive information of candidate UXOs to be determined when processed according to the techniques described herein.

In step 320, a first inversion is performed on the residual field data 208 to estimate a magnetic moment vector (including three orthogonal magnetic moment components) and to estimate a location of each candidate UXO represented by an anomaly region in the residual field data 208. The first inversion of step 320 is performed by the first inversion module 218 and relies on a first model function 220 that models the anomaly region as a dipole point source. The first inversion step 320 may initialize the iterative process with reasonable values for magnetic moment vector and the location of the candidate UXO using initialization processes performed by the model location initialization module 214 and the magnetic moment initialization module 262 as described herein. The first inversion step 320 iterates through different values for the magnetic moment vector and the location until an error is minimized or sufficiently reduced between the calculated magnetic field anomaly (according to all three orthogonal directions) produced by the first model function 220 and the observed magnetic field anomaly vector according to the residual field data 208. Step 320 thus estimates the three orthogonal components of the magnetic moment vector and the location of the candidate UXO in terms of orthogonal x, y and z (depth) directions.

In step 330, a second inversion is performed in which the candidate UXO is modelled as specified shape such as a prolate spheroid model. The second inversion step 330 determines an orientation of the candidate UXO using at least acoustic detection data 228 and fits values for the model parameters that sufficiently reduce or minimize an error between the estimated magnetic moment vector from the first inversion step 320 and a calculated magnetic moment vector according to the model embodied by the second model function 238. Some of the values for the model parameters may be guided by expected values according to expected UXO data 244 as described herein. The error produced by the second inversion of step 330 may be used to classify each candidate UXO in the residual field data 208 as being a probable UXO or not.

In step 350, an output is generated in which an indication as to whether each candidate UXO is classified as a probable UXO is given and in which a description of the candidate UXO produced by the second inversion of step 330 is provided. The description can include at least two dimensions (e.g., length and radius) of the candidate UXO and other descriptive items that have been determined including orientation and magnetic susceptibility. The probable UXOs may be synthetically represented in a magnetic chart image that has been produced according to the residual field data 208. The output of step 350 allows a practitioner to make more informed decision as to whether to investigate (by, e.g., interring) the probable UXO.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method for identifying marine unexploded ordinance (UXO), the method comprising:
receiving, via at least one processor, vector residual field magnetic data including georeferenced magnetic field data in three directions, the vector residual magnetic data including an anomaly created by a candidate UXO;
determining, via the at least one processor, a magnetic moment of the candidate UXO based on the vector residual field magnetic data;
determining, via the at least one processor, anomaly description data using the magnetic moment including an estimate of at least two dimensions of the candidate UXO;
determining, via the at least one processor, whether the anomaly description data fits with a reference description of a UXO to identify the candidate UXO as a probable UXO; and
providing, via the at least one processor, an output to an output device, an indication of the probable UXO.

2. The method of claim 1, wherein the anomaly description data includes an orientation of the candidate UXO.

3. The method of claim 1, wherein the anomaly description data includes a radius and a length of the candidate UXO as the at least two dimensions.

4. The method of claim 1, wherein the anomaly description data includes a magnetic susceptibility of the candidate UXO.

5. The method of claim 1, wherein determining the magnetic moment of the candidate UXO based on the vector residual field magnetic data includes performing a first inversion using a first model function representing a first model of the candidate UXO.

6. The method of claim 5, wherein the first inversion estimates a location of the candidate UXO in three dimensions.

7. The method of claim 5, wherein the first inversion includes a least squares inversion.

8. The method of claim 5, wherein the first inversion assumes the candidate UXO is a dipole point source as the first model.

9. The method of claim 1, further comprising:
receiving, via the at least one processor, orientation data describing an orientation of the candidate UXO and determining the anomaly description data uses the magnetic moment and the orientation data.

10. The method of claim 1, wherein determining the anomaly description data using the magnetic moment comprises performing a second inversion using a second model function representing a second model of the candidate UXO.

11. The method of claim 10, wherein the second inversion assumes the candidate UXO is a specified shape as the second model.

12. The method of claim 10, wherein the second inversion includes a first part that finds the estimate of at least two dimensions of the candidate UXO that best fits with reference UXO data, and wherein the second inversion includes a second part that determines a magnetic susceptibility of the candidate UXO based on the estimate of at least two dimensions of the candidate UXO from the first part.

13. The method of claim 5, wherein determining the anomaly description data using the magnetic moment comprises performing a second inversion using a second model function representing a second model of the candidate UXO, wherein the second inversion reduces an error between the magnetic moment provided by the first inversion and a calculated magnetic moment determined based on the second model function to provide values for parameters of the second model function, the values for parameters of the second model function included in the anomaly description data.

14. A system comprising:
one or more processors; and
one or more memories having stored thereon computer readable instructions, which when executed are configured to cause the one or more processors to:
receive vector residual field magnetic data including georeferenced magnetic field data in three directions, the vector residual magnetic data including an anomaly created by a candidate UXO;
determine a magnetic moment of the candidate UXO based on the vector residual field magnetic data;
determine anomaly description data using the magnetic moment including an estimate of at least two dimensions of the candidate UXO;
determine whether the anomaly description data fits with a reference description of a UXO to identify the candidate UXO as a probable UXO; and
provide to an output device, an indication of the probable UXO.

15. (canceled)

16. The system of claim 14, wherein the anomaly description data includes an orientation of the candidate UXO.

17. The system of claim 14, wherein the anomaly description data includes a radius and a length of the candidate UXO as the at least two dimensions.

18. The system of claim 14, wherein the anomaly description data includes a magnetic susceptibility of the candidate UXO.

19. The system of claim 14, wherein determining the magnetic moment of the candidate UXO based on the vector residual field magnetic data includes performing a first inversion using a first model function representing a first model of the candidate UXO.

20. The system of claim 19, wherein the first inversion estimates a location of the candidate UXO in three dimensions.

21. The system of claim 19, wherein the first inversion includes a least squares inversion.
